(19) United States
(12) Patent Application Publication
(10) Pub. No.: US 2026/0154846 A1
(43) Pub. Date: Jun. 4, 2026

(54) SHARING IMAGING INFORMATION FOR SENSING AND POSITIONING

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/965,269

(22) Filed: Dec. 2, 2024

(51) Int. Cl. G06T 7/73; G06T 7/11; H04B 17/391

(52) U.S. Cl. CPC G06T 7/74; G06T 7/11; H04B 17/3913; G06T 2207/10016; G06T 2207/20081; G06T 2207/30244

(57) ABSTRACT

Methods and apparatus for sharing information in a wireless network are disclosed. In some embodiments, techniques may include: receiving, from a first network node of the wireless network, environment imaging information relating to an environment of the wireless network, the environment imaging information including: visual imaging information of the environment obtained via a camera; non-visual imaging information of the environment obtained via an optical sensor, a radio frequency (RF) sensor, or a combination thereof; or a combination thereof; and performing, by a second network node of the wireless network, a sensing operation, a positioning operation, or a combination thereof using an output of a machine learning model of the second network node, the output produced based on the environment imaging information.

### BACKGROUND

### 1. Field of Disclosure

The present disclosure relates generally to the field of wireless communications, and more specifically to sharing information between wireless network nodes using radio frequency (RF) signals.

### 2. Description of Related Art

Prospective support for integrated sensing and communication is drawing attention in the wireless industry, the 3rd Generation Partnership Project (3GPP), and academia, particularly in wireless networks implementing 5G and 6G. Higher-bands communication for sensing (e.g., 5G millimeter wave or mmWave) has demonstrated its capabilities not only in high-speed communications but also in perceiving the physical environment. That is, apart from providing location services for devices such as positioning, environment sensing using 5G techniques can also estimate the position of target objects that do not carry any wireless equipment.

### BRIEF SUMMARY

In some aspects of the present disclosure, a method of sharing information in a wireless network is disclosed. In some embodiments, the method may include: receiving, from a first network node of the wireless network, environment imaging information relating to an environment of the wireless network, the environment imaging information comprising: visual imaging information of the environment obtained via a camera; non-visual imaging information of the environment obtained via an optical sensor, a radio frequency (RF) sensor, or a combination thereof; or a combination thereof; and performing, by a second network node of the wireless network, a sensing operation, a positioning operation, or a combination thereof using an output of a machine learning model of the second network node, the output produced based on at least a portion of the environment imaging information.

In some aspects of the present disclosure, a network apparatus is disclosed. In some embodiments, the network apparatus may include: one or more transceivers; one or more memories; a machine learning model; and one or more processors communicatively coupled with the one or more transceivers, the one or more memories, and the machine learning model, wherein the one or more processors are configured to: receive, from another network apparatus via the one or more transceivers, environment imaging information relating to an environment of a wireless network, the environment imaging information comprising: visual imaging information of the environment obtained via a camera; non-visual imaging information of the environment obtained via an optical sensor, a radio frequency (RF) sensor, or a combination thereof; or a combination thereof; and perform a sensing operation, a positioning operation, or a combination thereof using an output of the machine learning model, the output produced based on at least a portion of the environment imaging information.

In some aspects of the present disclosure, a non-transitory computer-readable apparatus is disclosed. In some embodiments, the non-transitory computer-readable apparatus may include a storage medium, the storage medium including a plurality of instructions configured to, when executed by one or more processors, cause a network apparatus of a wireless network to: receive, from another network apparatus, environment imaging information relating to an environment of the wireless network, the environment imaging information comprising: visual imaging information of the environment obtained via a camera; non-visual imaging information of the environment obtained via an optical sensor, a radio frequency (RF) sensor, or a combination thereof; or a combination thereof; and perform a sensing operation, a positioning operation, or a combination thereof using an output of a machine learning model of the network apparatus, the output produced based on at least a portion of the environment imaging information.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of a radio frequency (RF) sensing system.

FIG. 4 is a diagram showing an example of how beamforming may be performed, according to some embodiments.

FIG. 5 is a diagram of an example wireless environment illustrating various network nodes sharing vision information.

FIG. 6 shows an example mechanism for training a machine learning (ML) model, according to some embodiments.

FIG. 7 is a flow diagram of method of sharing information in a wireless network, according to some embodiments.

FIG. 8 is a flow diagram of method of sharing information in a wireless network, according to some embodiments.

FIG. 9 is a block diagram of an embodiment of a UE, which can be utilized in embodiments as described herein.

FIG. 10 is a block diagram of an embodiment of a base station, which can be utilized in embodiments as described herein.

FIG. 11 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communication and networking, and more particularly to enhancing sensing and positioning within a wireless network. Some aspects more specifically relate to sending and receiving of visual imaging information (such as camera image or video data) and/or non-visual imaging information (such as infrared, lidar, radio frequency (RF) data). Such information can be shared by a wireless network node (such as a base station or user device) with other wireless network devices to improve sensing of objects in the environment of the wireless network and/or positioning with respect to, e.g., the network device receiving the imaging information. In addition, a machine learning (ML) model can be trained and implemented to enhance sensing and positioning operations performed using at least the shared information. The shared information can be used in various ways other than enhanced sensing or positioning, such as performance monitoring, corroboration of imaging information obtained using different modalities (e.g., camera and radar), training of ML models, labeling of ground truth, selection of ML model to use, switching from or between ML models, among others discussed herein. Where ML-based performance is insufficient (as determined by monitoring), fallback options such as using a classical, signal-based algorithm, or using another ML model, are available.

Particular aspects of the subject matter described in this disclosure can be implemented to realize one or more of the following potential advantages. Sharing of visual and/or non-visual imaging information among network nodes in a wireless network can enhance sensing and positioning operations by a network node. Involving other network nodes can improve the performance of ML models used by a network node to perform the sensing and positioning operations. Using other network nodes increases the amount of information available to a node to perform the sensing or positioning, and leveraging nearby network nodes to monitor performance can ensure high accuracy of the sensing or positioning operations while reducing computing and/or bandwidth overhead.

Additional details will follow after an initial description of relevant systems and technologies.

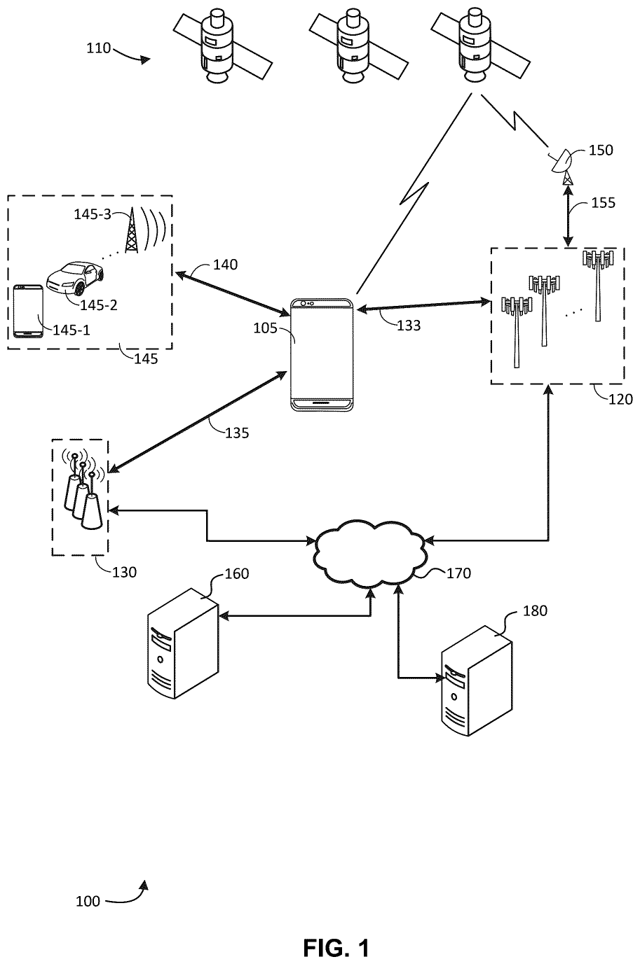

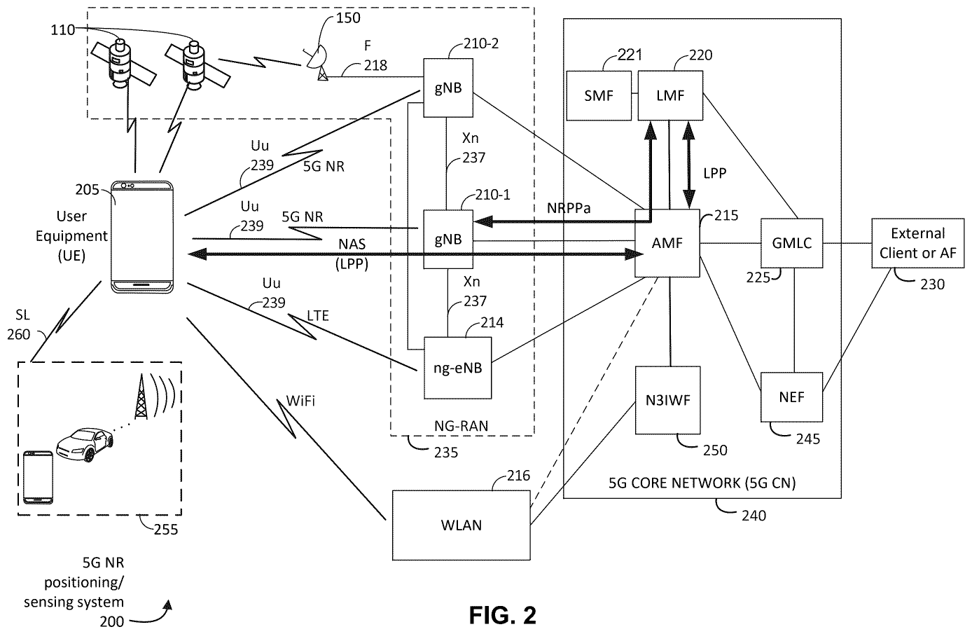

FIG. 1 is a simplified illustration of a positioning/sensing system 100 in which a UE 105, location/sensing server 160, and/or other components of the positioning/sensing system 100 can use the techniques provided herein for sharing imaging information for sensing and positioning, according to an embodiment. The techniques described herein may be implemented by one or more components of the positioning/sensing system 100. However, the techniques described herein are not limited to such components and may be implemented in other types of systems (not shown). The positioning/sensing system 100 can include: a UE 105; one or more satellites 110 (also referred to as space vehicles (SVs)) for a Global Navigation Satellite System (GNSS) (e.g., the Global Positioning System (GPS), GLONASS, Galileo, or Beidou) and/or Non-Terrestrial Network (NTN) functionality; base stations 120; access points (APs) 130; location/sensing server 160; network 170; and external client 180. UE 105 may also refer to a mobile device (or vice versa) in some contexts of the present disclosure. Generally put, the positioning/sensing system 100 can estimate a location of the UE 105 based on RF signals received by and/or sent from the UE 105 and known locations of other components (e.g., satellites 110, base stations 120, APs 130) transmitting and/or receiving the RF signals. Additionally or alternatively, wireless devices such as the UE 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location/sensing server 160, by accessing the network 170 via a base station 120 using a first communication link 133. Additionally or alternatively, because APs 130 also may be communicatively coupled with the network 170, UE 105 may communicate with network-connected and Internet-connected devices, including location/sensing server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, where the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

Satellites 110 may be utilized in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server, which may operate as a location/sensing server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of UE 105 and/or provide data (e.g., “assistance data”) to UE 105 to facilitate location measurement and/or location determination by UE 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location/sensing server 160. In some embodiments, the location/sensing server 160 may comprise a Discovered SLP (D-SLP) or an Emergency SLP (E-SLP). The location/sensing server 160 may also comprise an Enhanced Serving Mobile Location Center (E-SMLC) that supports location of UE 105 using a control plane (CP) location solution for LTE radio access by UE 105. The location/sensing server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location/sensing server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning/sensing system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the UE 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning/sensing system 100 can be implemented using a wireless communication network, such as an LTE-based or 5G NR-based network, or a future network (e.g., 6G network). FIG. 2 shows a diagram of a 5G NR positioning/sensing system 200, illustrating an embodiment of a positioning/sensing system (e.g., positioning/sensing system 100) implementing 5G NR. The 5G NR positioning/sensing system 200 may be configured to enable wireless communication, determine the location of a UE 205 (which may be an example of UE 105 of FIG. 1), performing RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods and/or one or more sensing methods. These access nodes can use RF signaling to enable the communication, implement the one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may be configured to coordinate RF sensing by the 5G NR positioning/sensing system 200. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning System (GPS) or similar system (e.g., GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNB 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMFs) 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning system/sensing 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216, or NTN satellite 110, or a combination thereof (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5 GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted or UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5 GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220, described in more detail hereafter.

Positioning of the UE 205 in a 5G NR positioning/sensing system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or

### “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

The principles described above with respect to positioning may be generally extended to RF sensing. That is, RF sensing may be UE based (e.g., originated from the UE) and/or UE assisted (e.g., originated from a non-UE entity), and may involve UL signals, DL signals, or both. However, RF sensing may differ from positioning in various ways. For example, as previously noted and described in more detail below, RF sensing may involve the use of specific RF sensing signals. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof).

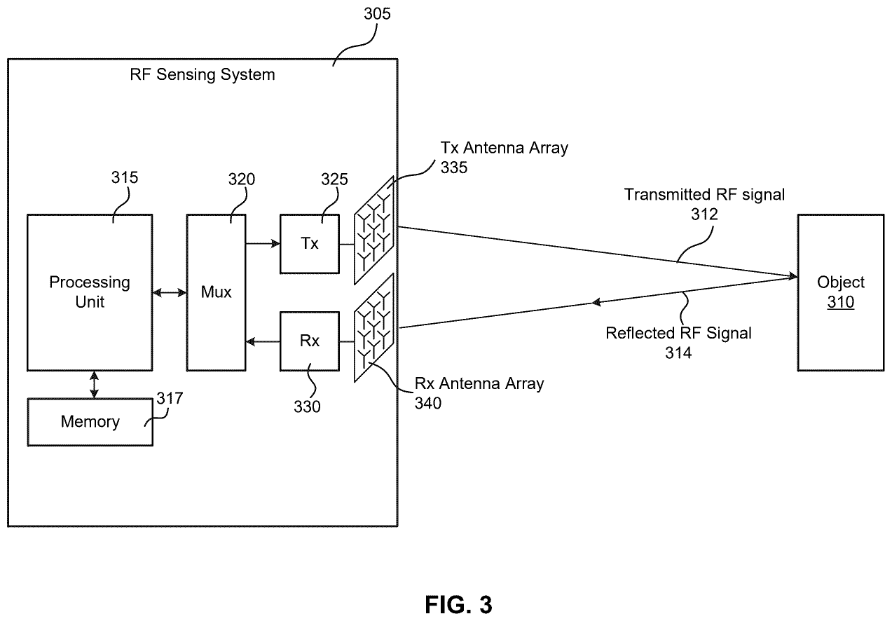

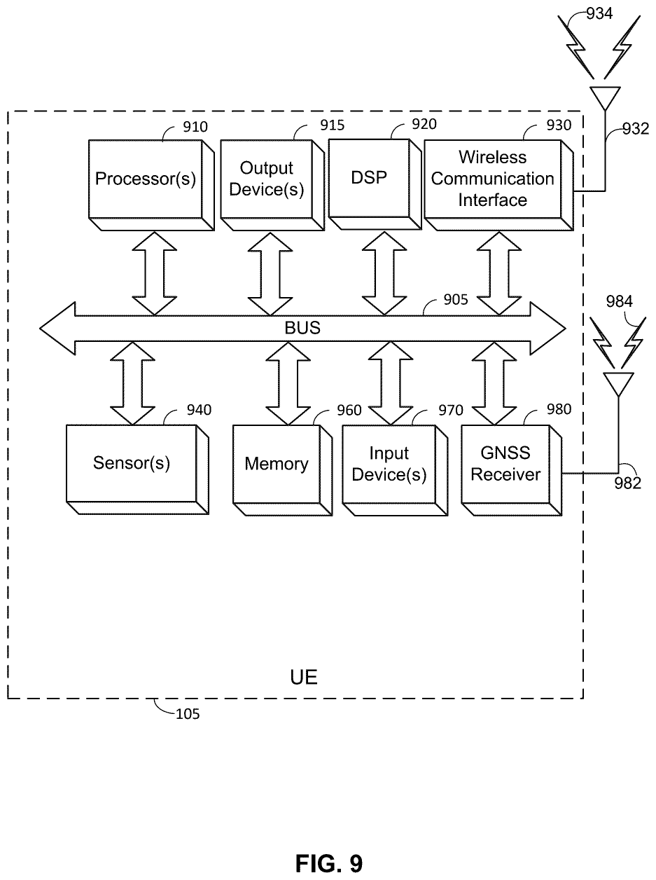

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device (e.g., the UE disclosed herein), such as a mobile phone, UE, a base station/access node, a satellite, or other type of sensing node as described herein. (Example components of such electronic devices are illustrated in FIGS. 9-11 , discussed in detail hereafter.)

Sensing algorithms may utilize monostatic sensing or bistatic or multistatic sensing. Monostatic sensing involves using a pair of co-located transmitter and receiver to sense the environment, while bistatic or multistatic sensing involves using separated transmitters and receivers to sense environment.

It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 may reflect off of the object 310, and these reflected RF signals 314 (or “echoes”) may then be processed by the RF sensing system 305 using beamforming (BF) and digital signal processing (DSP) techniques to determine the location of the object 310 (azimuth, elevation, velocity (e.g., from Doppler measurements), and/or range) relative to the RF sensing system 305. Constant false alarm rate (CFAR) detection may be part of this processing, but may not necessarily be used in every instance, or “occasion,” in which RF sensing is performed.

To enable RF sensing, RF sensing system 305 may in some implementations include a processing unit 315, a memory 317, a multiplexer (mux) 320, Tx processing circuitry 325, and Rx processing circuitry 330. Some implementations of the RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit 315 may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 may include a plurality of antenna elements. It can be noted that, although the antenna arrays 335, 340 of FIG. 3 can include two-dimensional arrays, embodiments are not so limited. Arrays may simply include a plurality of antenna elements along a single dimension that provides for spatial cancelation between the Tx and Rx sides of the RF sensing system 305. As a person of ordinary skill in the art will appreciate, the relative location of the Tx and Rx sides, in addition to various environmental factors can impact how spatial cancelation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in a mobile device or UE (e.g., 105, 205), including modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, XR streaming, public safety, search and rescue, and more. Further, RF sensing is expected to be incorporated into wireless standards (e.g., 5G, 6G), and therefore may be performed in the future in a cellular network.

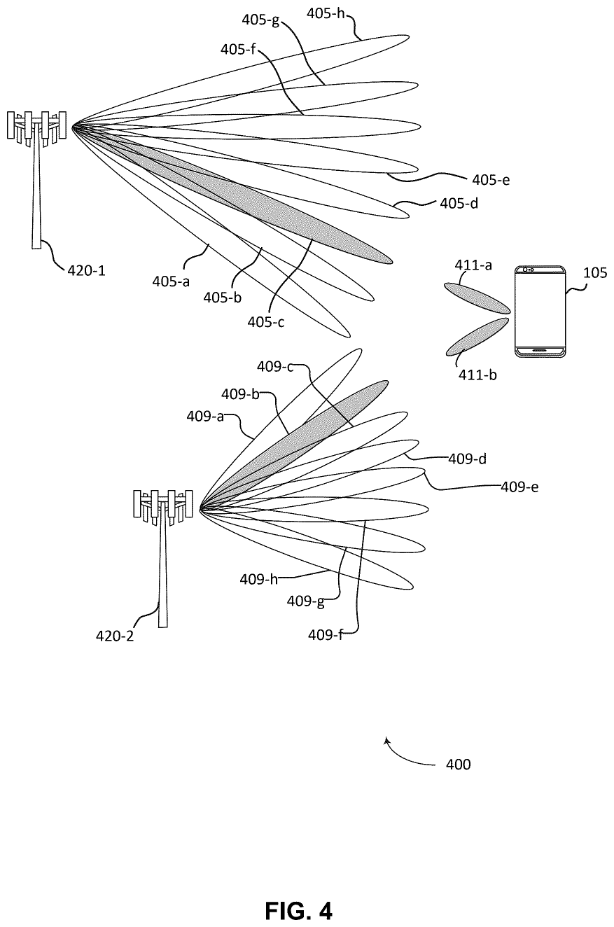

FIG. 4 is a diagram illustrating a simplified environment 400 including two base stations 420-1 and 420-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 4 also illustrates a UE 105, which may also use beamforming for transmitting and/or receiving RF signals. Such directional beams are used in 5G NR wireless communication networks. Each directional beam may have a beam width centered in a different direction, enabling different beams of a base station 420-1 or 420-2 to correspond with different areas within a coverage area for the base station 420-1 or 420-2.

Different modes of operation may enable base stations 420-1 and 420-2 to use a larger or smaller number of beams. For example, in a first mode of operation, a base station 420-1 or 420-2 may use 16 beams, in which case each beam may have a relatively wide beam width. In a second mode of operation, a base station 420-1 or 420-2 may use 64 beams, in which case each beam may have a relatively narrow beam width. Depending on the capabilities of a base station (420-1 or 420-2), the base station may use any number of beams the base station may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 420-1 or 420-2 may use beam sweeping. Beam sweeping is a process in which the base station 420-1 or 420-2 may send an RF signal in different directions using different respective beams, often in succession, effectively “sweeping” across a coverage area. For example, a base station 420-1 or 420-2 may sweep across 120 or 360 degrees in an azimuth direction, for each beam sweep, which may be periodically repeated. Each direction beam can include an RF reference signal (e.g., a PRS resource), where base station 420-1 may produce a set of RF reference signals that includes Tx beams 405-a, 405-b, 405-c, 405-d, 405-e, 405-f, 405-g, and 405-h, and the base station 420-2 may produce a set of RF reference signals that includes Tx beams 409-a, 409-b, 409-c, 409-d, 409-e, 409-f, 409-g, and 409-h. As noted, because UE 105 may also include an antenna array, it can receive RF reference signals transmitted by base stations 420-1 and 420-2 using beamforming to form respective receive beams (Rx beams) 411-a and 411-b. Beamforming in this manner (by base stations 420-1 and/or 420-2 and optionally by UE 105) can be used to make communications more efficient. They can also be used for other purposes, including taking measurements for position determination (e.g., AoD and AoA measurements).

As discussed herein, in some embodiments, TDOA assistance data may be provided to a UE 105 by a location server (e.g., location/sensing server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., N_{PRS}, T_{PRS}, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location/sensing server 160). More particularly, the RSTD for a neighbor cell “k” relative to a reference cell “Ref,” may be given as (ToAₖ-ToA_{Ref}), where the ToA values may be measured modulo one subframe duration (1 ms) to remove the effects of measuring different subframes at different times. ToA measurements for different cells may then be converted to RSTD measurements and sent to the location/sensing server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

### Visual and Non-Visual Imaging Information

In a broad sense, vision information may include and provide contextual data of the environment using visual imaging information and/or non-visual imaging information. The environment may refer to and include network nodes associated with a wireless network and/or at least portions of a physical area or space (including structures, surfaces, and other objects) surrounding or otherwise associated with a wireless network or network nodes thereof. Visually and non-visually detectable or sensed information using sensors and/or network nodes may also be considered part of the environment. Imaging may not be limited to visual sensing using a camera, as will be discussed below.

Consider a camera installed or deployed at fixed locations (e.g., security or traffic monitoring camera, at base stations or access points) or mobile devices (e.g., UEs, vehicles) to capture visual data. For example, such a camera may be configured to capture raw images and/or videos captured by the camera or device. In some cases, cameras may be distributed sensors placed in various locations and be in communication with one another or a device, e.g., at locations away from base stations or access points but communicatively coupled thereto.

As such, vision information may include visual imaging information of the environment, such as raw images or video data obtained via one or more cameras. In some example implementations, visual imaging information may be captured by and obtained from cameras disposed at vehicles.

In some implementations, post-processed data of raw images and/or videos may be used to generate data or data structures associated with the environment or objects in the environment. For example, a point cloud (collection of data points in three-dimensional (3D) space that represent the surface of an object), a segmentation map (an image or representation that is visually divided or segmented into distinct regions, e.g., based on certain features or characteristics), a depth map (an image or representation with indications of distance of object(s) from a viewpoint), or a heatmap (indicating distances, signal strength of network nodes, etc.) of the environment may be generated.

In some examples, a static classification of the environment may be determined, e.g., rural, urban, or sub-urban areas, with an associated confidence level. Other classifications the environment may include urban jungle, underground, tunnel, open field, etc. In some examples, a dynamic state of the environment may be determined, e.g., heavy or light traffic density, with an associated confidence level and/or timestamp.

In addition, vision information may include non-visual imaging information of the environment. Examples of non-visual imaging information may include sensors of types other than a visual camera, such as an optical sensor (e.g., lidar, infrared (IR) camera) and/or a radio frequency (RF) sensor (e.g., radar). Further examples may include an ultraviolet (UV) sensor and/or an acoustic sensor (e.g., microphone, sonar).

Any combination of the types of sensors mentioned herein may be used to obtain visual imaging information and/or non-visual imaging information of the environment. In some example implementations, a camera may be used to capture visual imaging information of the environment. In some example implementations, an optical sensor and an RF sensor may be used to capture non-visual imaging information of the environment. In some example implementations, a camera, an optical sensor, and an RF sensor may be used to capture visual and non-visual imaging information of the environment.

Hence, vision information (including visual and non-visual imaging information as discussed above) can summarize the scene or environment where communications take place, particularly wireless communications. Performance of communications, positioning, and sensing occurring within the environment can be enhanced by exploiting the vision information.

One area of enhancement is performance monitoring. Vision information may enable assessment of performance of positioning or sensing techniques and algorithms. This can be done by, for example, comparing the difference or error between RF-based sensing or positioning and camera-based sensing or positioning. A low error (e.g., difference between RF and visual sensing) may imply or produce a determination of good performance. Based on this determination, the network or a networked device (including, e.g., a network node or a UE) can rely on the sensing or positioning resulting from visual or camera-based sensing or positioning (or RF-based sensing), as it has been corroborated using another sensing modality. On the other hand, a high error may imply or produce a determination of low performance. In this case, the network or a networked device may not rely on sensing or positioning results from the visual (or RF-based) sensing or positioning. In some approaches, the network or networked device may take further actions to enhance sensing results. Some such remedial actions may include switching or finetuning the sensing algorithm, e.g., updating one or more parameters of a machine learning (ML) model that outputted the sensing or positioning result.

Another area of enhancement is performing sensing or positioning using both visual and non-visual information—that is, using both visual imaging information and non-visual imaging information (e.g., RF information). Instead of relying only on RF sensing, for example, the network or a networked device may combine RF sensing information (e.g., from a radar) with visual sensing information (e.g., from a camera) to improve the sensing or positioning result. As another example, sensing information from the modality having the least amount of error or highest confidence level associated with it may be used for final position determination or sensing output.

Another area of enhancement is dataset labeling. To train or finetune ML model(s) to sense an environment or position a device, the network or a networked device may use labeled data associated with target locations, objects, surfaces, etc. Such labeled data can be obtained from the network or other networked devices that have processed and/or labeled vision information (which, again, may include visual imaging information and/or non-visual imaging information.

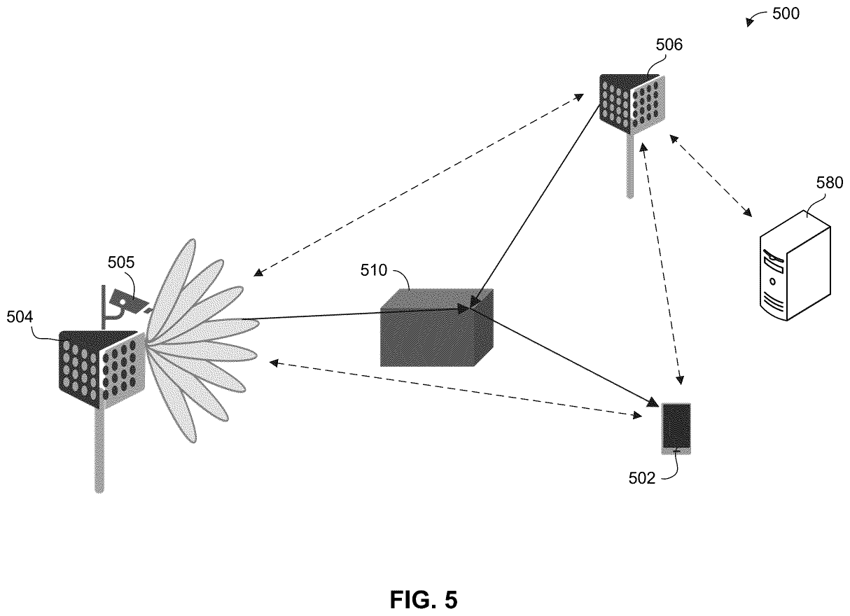

Refer now to FIG. 5, which is a diagram of an example wireless environment 500 illustrating various network nodes sharing vision information. In some scenarios, the environment 500 may include, for example, a mobile device 502, a first network node 504, a second network node 506, and an object 510. The mobile device 502, the first network node 504, and/or the second network node 506 may be configured to perform data communication with a server entity 580. The mobile device 502 may be an example of UE 105, UE 205, RF sensing system 305. In some cases, mobile device 502 may be a vehicle. The first network node 504 and the second network node 506 may each be an example of base station 120, AP 130, gNB 210, ng-eNB 214, or another radio access node (e.g., small cell, femtocell). The server entity 580 may be an example of location/sensing server 160, external client 180, or LMF 220, or any network entity residing in the core network. In some cases, the mobile device 502 may be operable while fixed (e.g., to a structure), and the first network node 504 and the second network node 506 may be movable (e.g., installed on a movable platform). In the context of the present disclosure, each of the mobile device 502, the first network node 504, and the second network node 506 may be wireless-enabled and referred to as a network node. In some cases, the server entity 580 may also be referred to as a network node. Example components of the mobile device 502, the first network node 504, the second network node 506, and the server entity 580 are illustrated in FIGS. 9, 10 and 11. The object 510 may be any physical object within the environment 500, such as an occlusion or obstruction (e.g., building), a wall or other surface, a road, the ground, a street sign, a traffic light, flora (e.g., a tree, a bush), a vehicle, a pedestrian, and so on.

In some scenarios, one or more of the network nodes may have a sensor associated therewith. For example, the first network node 504 may comprise at least one sensor 505, each of which may be a visual sensor (e.g., a camera), an optical sensor (e.g., IR sensor, lidar), or an RF sensor (e.g., radar). That is to say, sensor 505 may be or include a sensor configured to obtain visual imaging information or non-visual imaging information. Although not explicitly shown, mobile device 502 may also include one or more sensors of the above type, and the second network node 506 may also include one or more sensors of the above type.

In some embodiments, the mobile device 502, the first network node 504, and/or the second network node 506 may each have and/or implement a ML model configured to (e.g., trained to) perform a sensing operation and/or a positioning operation based on the visual imaging information and/or non-visual imaging information.

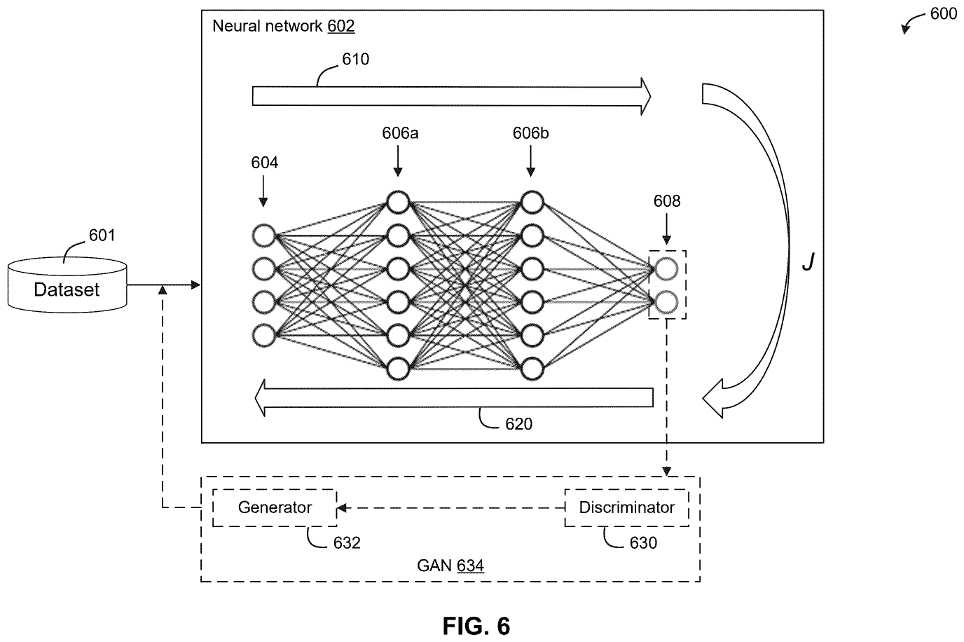

An example mechanism 600 for training a machine learning (ML) model, according to some embodiments, is depicted in FIG. 6. The example mechanism 600 may include a training module configured to perform the training of the ML model. The example mechanism 600 may include a neural network 602. According to some implementations, neural network 502 may include an input layer 604, an output layer 608, and one or more intermediate “hidden” layers 606a, 606b between the input and output layers. In some implementations, hidden layers may not be present between the input and output layers. In some cases, hidden layers may not be present between the input and output layers.

The neural network 602 may represent an algorithm, represented by the layers. Each layer may include one or more nodes, each of which may contain a value or represent a computational function that has one or more weighted input connections, a transformation function that combines the inputs in some way, and/or one or more output connections (which may in turn be input connections to other nodes). The input layer 604 may be configured to receive external data 601. The external data 601 may include training data from a database (e.g., storage) or obtained from a network node. In some implementations, a portion (e.g., 20%) of the training data may be randomly selected to be used as part of a validation set for the machine learning model. Each of the hidden layers 606a, 606b may be configured to perform at least a transformation on the inputs. The output layer 608 may be configured to produce a result of the transformations. In some implementations, the result may include predicted wireless measurement information, e.g., positioning information relating to position or location of a network node, or sensing information relating to position or location of an object in an environment. The neural network 602 may be configured to output predictions for various other types of wireless measurement information, an example of which may include (but is not limited to) a prediction of signal power associated with a wireless device or network node at a given position. In further examples, other types of wireless measurement data may be predicted (e.g., RSRP, signal-to-noise ratio (SNR)).

As an example implementation, one or more nodes of the input layer 604 may receive vision information, e.g., visual imaging information from a camera and/or non-visual imaging information from an optical sensor and/or an RF sensor. For instance, the first network node 504 may send vision information to the second network node 506. In some cases, the vision information may be obtained at least in part by the first network node 504 via a sensor 505, or it may be obtained at least in part from another network node. The second network node 506 may include a ML model that is configured to (e.g., trained to), based on the received vision information, perform an operation. In some implementations, such an operation during inference (e.g., output of prediction using a trained ML model) may involve outputting predicted information for a sensing operation to determine position or location of an object and/or a positioning operation to determine a position or location of a network node (e.g., mobile device 502). The output may be based on the vision information received via the input layer 604.

During training, one or more hidden layers 606a, 606b may receive the output of the input layer 604, apply one or more weights associated with a given connection between neural nodes, and produce a training output that contains predicted information for positioning a device or sensing an object. In some examples, ground truth labels may include absolute positions of a network node or other objects, or positions (e.g., distance, angle) relative to the sensing network node (e.g., first network node 504 with sensor 505). Labeled data may refer to data having ground truth indicating information that is known to be real or true, provided by direct observation or measurement (but may not necessarily be accurate). Labeled data can be used for training the ML model, or finetuning a trained ML model (e.g., further training on new data to adjust or update weights, which may adapt the ML model to a specific use case). A correlation may exist between the vision information and the predicted information. In some implementations, the training output may contain wireless measurements, e.g., signal power, SNR. The process of producing an output from the input may be referred to as forward propagation 610.

In some embodiments, a modeling process may be performed, e.g., a linear regression, to improve the predictions by the machine learning model. In some embodiments, the modeling process may be logistic regression, which may determine a probability of an outcome given an input, useful for classifying an output (e.g., yes or no, 1 or 0). In linear or logistic regression, an error (J) may be determined between the output data (e.g., predicted positioning or sensing information) and ground truth labels of locations or positions of objects or network nodes, and minimized using an optimization technique such as gradient descent. In gradient descent, the error is sought to be lowered at each iterative step until a minimum error is reached. In some implementations, linearization may be performed to reduce dimensions and/or learning rate may be set and/or adjusted. In some cases, a learning rate schedule may be set to vary the learning rate to reach the global minimum error without running into nonconvergence from an overly large learning rate or being stuck in local minimum from an overly small learning rate. The process of updating the weights of the connections in the neural network 602 based on the optimization process may be referred to as backpropagation 620.

Forward propagation 610 may then be performed again with the updated connection weights, with another backpropagation 620 based thereon. This cycle may be performed one or more times by the training module or example mechanism 600.

In some embodiments, additional input data may be utilized with the neural network 602. More specifically, a discriminator 630 and a generator 632 may optionally be implemented with the neural network 602. A discriminator is a type of neural network configured to learn to distinguish fake data from realistic fake data that may have the same characteristics as the training data and generated by the generator 632. The discriminator 630 and the generator 632 may compete with each other, and the discriminator 630 may penalize the generator 632 for generating data that is easily recognized as implausible. By using the discriminator 630 and the generator 632 together in such a way as a generative adversarial network (GAN) 634, more realistic and plausible examples may be generated by the generator 632 over time. In this way, a GAN may be used to increase the training dataset size, and in some embodiments, data in addition to those collected, e.g., vision information, may be used for training.

In some implementations, the resulting output may include values (coordinates, distance, angle, etc.) included in a predefined format (comma-separated values (CSV), table, vector, etc.). Such values may indicate a location or position of one or more objects in the environment (sensing) or of the network node implementing the ML model (positioning). In some implementations, the output may include a probability associated with the predicted location of the object or network node. The final sensing or positioning output may consider the probability of the predicted location. For example, determination of a location of a network node or an environmental object may include a determination that the probability of the predicted location (output from the ML model) meets to exceeds a threshold.

In some implementations, the resulting output may include heatmap data that indicates the estimated or predicted wireless measurements with respect to two-dimensional (e.g., two of x, y, or z) or three-dimensional (e.g., x, y, z) location within an environment associated with a wireless network. Heatmap data may indicate error ranges and confidence levels, e.g., using gradients of colors or brightness. Such heatmap data may represent a collection of predictions at various locations, and may include, e.g., indications of one or more predicted locations of objects in the environment. Other types of data structures as noted above (e.g., point cloud, segmentation map, depth map) may be generated as output or during post-process.

In some embodiments, the training of the machine learning model may be performed at a network node, such as an access point or a base station (e.g., gNB), or a mobile device (e.g., UE), or a server entity (e.g., location/sensing server 160, external client 180, LMF of the location server 160). While the above-mentioned example implementation involves the second network node 506 receiving the vision information and using it to train a ML model, it will be recognized that the mobile device 502, the first network node 504, and the second network node 506 may each be examples of a network node at which training may occur.

In some embodiments, inference based on a trained machine learning model may be performed at a network entity or entities. In some implementations, the resulting output generated by the network entity may be used by the network node implementing the ML model, or the output may be sent to another network node or another part of the network (e.g., the server entity). In some embodiments, inference may be performed at a network node based on a trained model received from another network node, as will be discussed in greater detail below. The resulting output may then be used as part of a position method to estimate the location or position of a network node or a sensing method to estimate the location or position of objects in the environment.

To these ends, a network node (e.g., mobile device 502, first network node 504, second network node 506) may be configured to share (e.g., transmit or receive) vision information, including visual imaging information and/or non-visual imaging information associated with the environment 500, which may be obtained via the one or more sensors associated with each of the network nodes (e.g., sensor 505). Vision information may be obtained by performing wireless communication, including exchange of wireless signals with other network nodes and/or interaction with objects such as object 510 using wireless signals (e.g., laser pulses sent and received using lidar, RF signals sent and received with radar, visual signals received with camera). For example, visual and/or non-visual imaging information may be obtained with respect to object 510, and sent to or received from other devices via wireless signals. Such vision information may enable adaptation and enhancement of sensing and positioning techniques.

Implementations of sensing and positioning techniques may include: (i) monitoring the performance of sensing or positioning techniques or algorithms, (ii) integrating both RF-and vision-based information to enhance sensing or positioning performance, (iii) labeling of datasets and training data (trainsets) to enable finetuning, training, or re-training of the ML models, (iv) selecting an appropriate trained ML model based on the scenario identified from the vision information, (v) switching or updating ML model trained for sensing or positioning, and/or (vi) transferring ML models to other network nodes across scenarios based on the similarity of vision information.

To effectuate the above approaches, vision information may be used in various ways as described below.

### Vision Information Sharing

In some embodiments, a first communication node may share vision information with a second communication node. For example, first network node 504 may share visual imaging information and/or non-visual imaging information with second network node 506, or with mobile device 502. The shared vision information may be received, stored, processed or post-processed, and/or used by the receiving network node. Some example uses may include training and implementing a ML model configured to enable a network node implementing the trained ML model to perform a positioning operation or a sensing operation, e.g., by outputting a prediction of a final position solution of the network node or location(s) of object(s) sensed. Any type of communication node, such as one or more (including groups of) UEs, base stations (e.g., gNBs), or other network entities such as intermediary nodes, edge nodes, servers (AMF, LMF, location/sensing server, etc.) may participate in sharing, including sending and/or receiving.

In some embodiments, information sharing may be triggered by the first, sending communication node, or in response to a request or inquiry from the second, receiving communication node. In some implementations, the request may include information such as a requested type of information (e.g., raw or processed image or video, visual or non-visual imaging information, reference location or position of sending node, known object location or position, a type of ML model) and/or a condition or bounds of the information (e.g., image of a specific area or direction in an environment; size, age, confidence, resolution of the information).

In some embodiments, the vision information delivered to another network node may include additional information beyond the vision information. As examples, the first communication node may share at least some the following types of information with the second communication node:

Meta information such as position, direction, angle, capabilities of the sensor, or a time stamp associated with vision information or other information sent to another network node. In different configurations, the sensor may be communicative with but not necessarily co-located with the network node.

Position of the first, sending communication node. Such position may be an absolute position (e.g., global coordinates) or relative to a sensor or to another network node (e.g., the second, receiving communication node).

Object information, such as segmentation of environmental objects in an image, or any motion associated with the objects (position, orientation, trajectory, Doppler frequency, etc.). Segmentation may be performed using techniques described below, such as edge detection methods among others.

Annotation information associated with vision information. Annotations may include ground truth labels. In some cases, such labels may include or be associated with one or more relevant network nodes (e.g., the position of the first or second nodes in an image).

Association with communication resources, e.g., base stations or other network nodes, or radio communication beam(s) (e.g., Tx beam(s) 405 or Rx beam(s) 409) associated with the area or direction of a view within the image.

In some embodiments, the vision information shared to or received by a network node may be encapsulated in single or multiple messages. In some cases, multiple messages may be in the form of a multi-stage message that contains one or more other message within its structure. In some cases, prior information may be successfully updated or refined with multiple messages.

As mentioned above, the vision information may enable adaptation and enhancement of sensing and positioning operations, and may include various types of imaging information, e.g., image or video data from a visual camera, IR camera, lidar, radar, etc. Additionally, other types of information may be derived from the imaging information. For example, depth information may be determined from such imaging information using image processing techniques described elsewhere herein. As another example, size, age, timestamp, resolution, and other metadata associated with the image data may be obtained with the imaging information. A network node may share the vision information it has acquired (e.g., via one or more of its sensors, or from another network node) with one or more other network nodes.

In some embodiments, a network node may implement a ML model trained according to methodologies described elsewhere herein. As such, the network node may use the ML model to perform a positioning operation or a sensing operation, e.g., by outputting a prediction of a final position solution of the network node or location(s) of object(s) sensed. In some implementations, a confidence level associated with the positioning or sensing operation may also be output from the ML model. For example, the ML model may output one or more possible predicted locations and associated probabilities, e.g., in a distribution. In some cases, the location having a probability exceeding a threshold may be output as the final solution (and if not, no output may be given). In some cases, the location having the highest probability out of all the predicted locations (one predicted location has a higher probability than other predicted locations) may be output, regardless of whether it exceeds the threshold.

### Protocols for Sharing Vision Information

Vision information may enable sensing and positioning, and enhancements thereto, by the receiving network node. Certain channels or protocols may be utilized when sharing vision information (and/or additional information as listed above).

In some implementations, LPP or NRPPa as defined elsewhere above may be used as messaging protocols, e.g., in an LTE or NR wireless network. In some implementations, Uu, F1, Xn, or other types of interfaces may be used to share vision information. In some implementations, the Radio Resource Control (RRC) protocol may be used for sharing vision information between a UE and a base station. In some implementations, system-level information may be shared, e.g., Uplink Control Information (UCI) carried via Physical Uplink Control Channel (PUCCH), Downlink Control Information (DCI) carried via Physical Downlink Control Channel (PDCCH), inter-UE coordination message delivered via sidelink, or MAC (Medium Access Control) Control Element (MAC CE). In some implementations, information sharing may be performed through different types of links. For example, vision information may be broadcast or transmitted via unicast links.

In some embodiments, multiple serving nodes (e.g., TRPs of base stations) may provide vision information to the same receiving network node (e.g., UE). In some configurations, the receiving network node (e.g., UE) may select a Multiple Transmission and Reception Point (mTRP) scheme to receive the vision information. Examples of mTRP schemes may include space-division multiplexing (SDM), frequency-division multiplexing (FDM), time-division multiplexing (TDM), Single Frequency Network (SFN)-based transmissions, or dynamic point selection (DPS) transmission.

mTRP communications may advantageously enable use of higher bandwidth than at least some of the above types of channels and protocols, as mTRP enables base stations to use more than one TRP to communicate with a UE and can improve network performance. mTPR may be particularly advantageous in sensing or positioning algorithms, where a UE may need to, e.g., receive positioning reference signals or additional sensing or positioning information from multiple TRPs to sense the environment.

In some embodiments, multiple serving nodes (e.g., TRPs) may provide vision information to a network entity such as a server residing in the core network (e.g., AMF, LMF, location/sensing server, etc.), or a local RAN entity (e.g., CU, DU, RU) connected to the TRPs. In some cases, the network entity may store and process the vision information (e.g., using post-processing approaches discussed above). Processed vision information may be used for network-side ML model training and selection. In some implementations, the network entity may assist with UE-side ML model selection based on the vision information received at the UE. Different ML models may be trained to perform sensing or positioning based on different types of vision information. For example, a given ML model may have be trained on visual imaging information such as camera images or video, or non-visual imaging information such as IR-or RF-based data or images. The network entity may then, in some cases, provide an appropriate ML model proactively or based on a request for an appropriate ML model received from the UE or another network node. In some implementations, the network entity may assist mTRP resource configuration and adaptation based on the vision information.

### Dataset Labeling Based on Imaging Information

In some embodiments, a wireless network or a network node (e.g., mobile device 502, first network node 504, second network node 506) may share vision information with other network nodes to assist with obtaining ground truth labels to train a ML model or finetune a trained ML model.

For example, consider a network node configured to use an ML model trained to sense the environment using RF data acquired using an RF sensor (e.g., radar). The network node may also be configured to obtain, e.g., from another network node, visual imaging information (e.g., images or videos captured using a camera or received from another network node) and ground truth labels indicative of actual locations of objects in the environment. In different scenarios, at least portions of such ground truth labels may be created and labeled by the other network node that has captured the visual imaging information, or at least portions of the ground truth labels may be received from yet another network node other than the network node capturing the visual imaging information. The other network node may share the visual imaging information along with the ground truth labels to the network node using the ML model.

In an illustrative example, the network node (e.g., first network node 504) may obtain images and/or videos using a camera (e.g., sensor 505). The network node may further be configured to generate ground truth labels using image analysis or other computer vision techniques. For instance, analysis logic may be implemented by the network node to perform an image processing routine such as segmentation or other edge finding routine. For instance, an edge detection method such as segmentation may be used to find edges or boundaries of objects in the environment within an image or video (multiple image frames). For instance, keypoints may be identified and matched between multiple images, e.g., using image processing algorithms such as scale-invariant feature transform (SIFT) feature detectors, and/or feature matching algorithms such as Fast Library for Approximate Nearest Neighbors (FLANN)-based methods to choose the best algorithm and optimum parameters (or using similar methods optimized for fast nearest neighbor search in large datasets) and find matches. Further processing of camera images may include (a) data reduction, (b) denoising (e.g., gaussian blur) and/or (c) edge detection thresholding (e.g., a Canny sequence of filter). The analysis logic may also employ a threshold-based method or its own ML-based or deep learning model to identify objects, boundaries, or edges in an image. The ground truth labels may result from at least some of the above techniques, and may include edge or feature information and/or absolute or relative locations of objects from other objects.

Continuing with the illustrative example, the ground truth labels generated this way may then be sent (along with the visual imaging information, e.g., camera images) by the network node to a mobile device or UE or other network node (e.g., mobile device 502) implementing a ML model configured to perform a positioning operation or a sensing operation using non-visual imaging information such as RF information from the environment. The receiving network node (e.g., mobile device 502) may be configured to use the shared visual imaging information and the ground truth labels associated with the visual imaging information to train, retrain, or finetune the ML model.

Note that the ML model in this example may be configured to use non-visual imaging information to perform the operation, and further training may be done using visual imaging information (and its ground truth labels). Hence, training using different imaging modalities can enhance performance of the ML model outputs for positioning or sensing, and this enhancement may be enabled by leveraging information obtained or captured from other nodes in a wireless network.

### Sensing and Position Performance Monitoring

In some embodiments, a wireless network or a network node may share vision and/or non-vision information with other network nodes to enable monitoring of the performance of a ML model.

In a sensing example, a network node (e.g., mobile device 502, first network node 504, second network node 506) may obtain sensed information, such as non-visual imaging information based on RF data, which, as discussed above, may be obtained using an RF sensor in some scenarios. Reflected RF signals 314 may be an example of the RF data. In some approaches, the network node may sense the environment by using sensed information, including non-visual imaging information (e.g., RF data), to determine locations of objects in the environment of the network node.

In some approaches, a network node (such as a UE) may receive sensed information from another network node to enable monitoring of the performance of the network node. By way of an example, a UE (e.g., mobile device 502) may receive vision information from a network node (e.g., first network node 504), and the vision information may be used to monitor the sensing performance by the UE.

In some implementations, monitoring may involve comparing the RF data (or other types of sensed information) sensed by the UE (or other network node) with the sensed information received from another network node. Monitoring may occur in multiple ways, such as at predetermined intervals, at dynamically determined intervals (based on type of environment, number of objects, time of day, etc.), or by network request. Monitoring occasions may occur less frequently than RF sensing and obtaining of RF data.

Consider a scenario in which the sensed information by the UE (e.g., RF data) indicates that an object is at a certain location (e.g., absolute position such as a global coordinate, or relative to the UE at a certain distance from the UE). Vision information received by the UE from another network node may indicate that the object is indeed at the location indicated by the sensed information by the UE, which may be considered to correspond to good performance in RF sensing by the UE. In some cases, the location may be within a range of error or uncertainty to be considered good sensing performance. On the other hand, if the received vision data indicates that the sensed object is at a different location, or outside of the error or uncertainty range, then the performance may be considered low or insufficient, or otherwise not meeting a performance criterion. In some cases, multiple determinations that the sensed information (e.g., RF data) from the UE and sensed information (e.g., vision information) the other network node are different (e.g., locations based on the respective sensed information do not correspond sufficiently) may be needed to determine that the sensing UE has an insufficient level of performance. In this way, sensing performance by the UE can be monitored by confirming or corroborating with vision information from another network node. Similarly, in some approaches, positioning performance by the UE can be monitored by comparing the RF data received from the network node with location information of the UE.

On the other hand, in some examples, the UE may share its sensed information to another network node. For example, the UE may share its sensed RF data to the other network node. The other network node may monitor the performance of the UE's RF sensing based on vision information obtained at the network node. No sharing of the vision information may be needed in this case if the vision information is available at the network node. However, the network node may obtain vision information from another network node in some scenarios. The vision information at the network node may be compared at the network node with the RF data from the UE, and evaluated for performance. Hence, a given network node (such as a UE) or another network node may monitor the sensing algorithm performance of the given network node.

In some embodiments, if sensing (or positioning) performance by the UE (or a network node generally) is determined to be low or insufficient, one or more fallback actions or mechanisms may be triggered. In some implementations, the network (e.g., location/sensing server 160 or gNB), may trigger the UE (or the sensing node) to fall back to a non-ML sensing algorithm. That is, in some examples, a classical, signal-based algorithm, such as one based on TDOA, may be used to perform sensing or positioning, instead of a ML model, if such a model was being used by the UE to perform the low-performance sensing or positioning. In some examples, the ML model being used for sensing or positioning may be switched to another ML model. The network (such as another network node or another UE) may provide one or more ML models. In some approaches, sensing performance may be assessed to be below a first threshold but above a second threshold, in which case, the ML model may be switched; and where performance deviation is large (e.g., sensing performance is below the second threshold), it may result in falling back to a signal-based algorithm from the ML model being used for sensing or positioning. In some examples, the UE may switch to using a ML model from a signal-based algorithm, if such a signal-based algorithm was being used by the UE to perform the low-performance sensing or positioning. Hence, the UE (or network node) may switch between different types of sensing (or positioning) algorithms based on performance.

Advantageously, monitoring sensing or positioning performance can reduce computing and/or bandwidth overhead compared to using vision information in performing the sensing the environment or performing positioning. More directly, the vision information for performance monitoring may only need be shared during monitoring events, rather than every time a network node is performing sensing.

### Example Methods

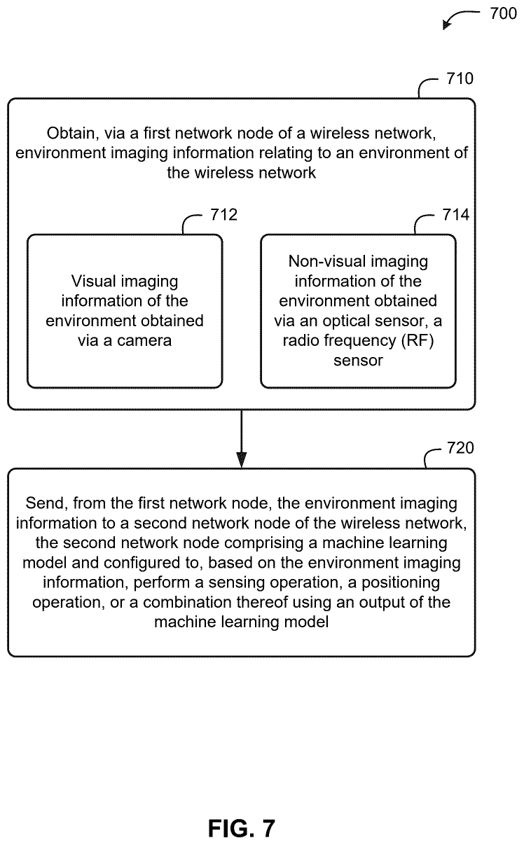

FIG. 7 is a flow diagram of a method 700 of sharing information in a wireless network, according to some embodiments. Structure for performing the functionality illustrated in one or more of the blocks shown in FIG. 7 may include hardware and/or software components of a network node, such as, for example, a controller apparatus, a computerized system, or a computer-readable apparatus including a storage medium storing computer-readable and/or computer-executable instructions that are configured to, when executed by at least one processor apparatus, cause the at least one processor apparatus or the network node to perform the operations. Example components of a network node, e.g., UE, base station, and/or server, are illustrated FIGS. 9, 10 and 11, which is described in more detail below.

It should also be noted that the operations of FIG. 7 may be performed in any suitable order, not necessarily the order depicted in FIG. 7. Further, the process shown in FIG. 7 may include additional or fewer operations than those depicted in FIG. 7.

At block 710, the method 700 may include obtaining, via a first network node of the wireless network, environment imaging information relating to an environment of the first network node. In some embodiments, the environment imaging information may include vision information, including: visual imaging information 712 of the environment obtained via a camera, non-visual imaging information 714 of the environment obtained via an optical sensor, a radio frequency (RF) sensor, or a combination thereof.

In some cases, the visual imaging information of the environment may include raw image or video data, one or more processed images or videos, or a combination thereof. In some cases, the visual imaging information of the environment may include segmentation information associated with one or more objects in the environment.

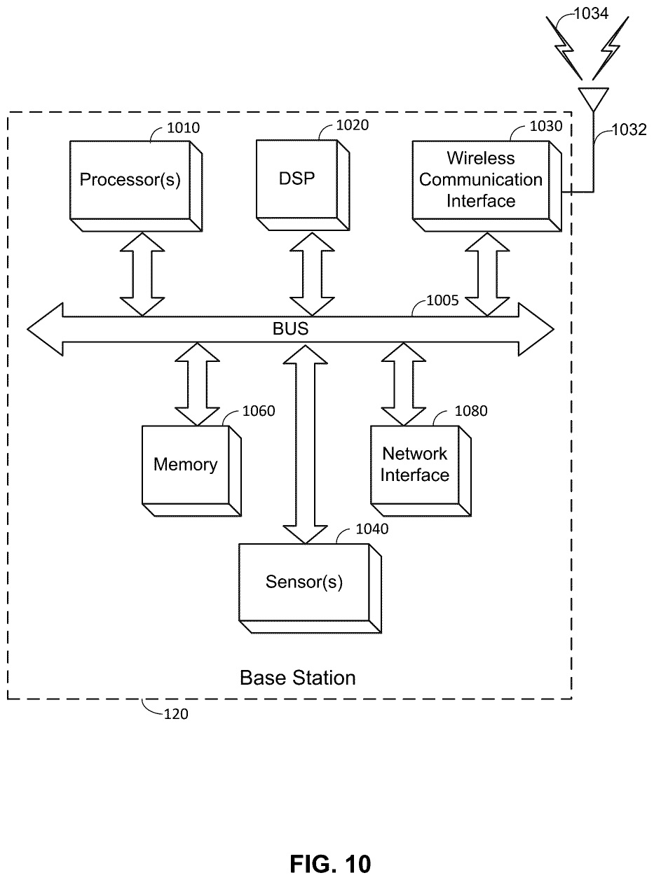

Means for performing functionality at block 710 may comprise sensor(s) 940, sensor(s) 1040, and/or other components of a UE or a base station, as illustrated in FIGS. 9 and 10.

At block 720, the method 700 may include sending, from the first network node, the environment imaging information to a second network node of the wireless network, the second network node comprising a machine learning model and configured to, based on the environment imaging information, perform a sensing operation, a positioning operation, or a combination thereof using an output of the machine learning model.

In some cases, the second network node may be configured to process the raw image or video data.

In some implementations, the first network node may include a first user equipment (UE), a first base station, or a first wireless access point; and the second network node may include a second UE, a second base station, or a second wireless access point.

In some embodiments, the performing of the sensing operation, the positioning operation, or the combination thereof may include: inputting at least a portion of the environment imaging information to the machine learning model, wherein the machine learning model is trained using (i) ground truth information known to the wireless network, and (ii) environment imaging information obtained by the first network node, the second network node, or a combination thereof; and using the machine learning model to output information for the sensing operation, the positioning operation, or the combination thereof. Thus, an artificially intelligent approach to sensing and/or positioning may be performed and enhanced using a ML model.

In some embodiments, the sending of the environment imaging information to the second network node may be responsive to a request from the second network node.

In some embodiments, the sensing operation, the positioning operation, or the combination by the second network node may include monitoring an operation performance by the second network node using the environment imaging information. in some implementations, the method 700 may further include, based on the operation performance, enabling, via the second network node: a signal-based sensing operation, a signal-based positioning operation, or a combination thereof; a machine learning model-based sensing operation, a machine learning model-based positioning operation, or a combination thereof; receiving a new machine learning model for the machine learning model-based sensing operation or the machine learning model-based positioning operation; or a combination thereof. For example, the signal-based sensing operation, the signal-based positioning operation, or the combination thereof may be based on a classical approach such as TDOA.

In some implementations, the monitoring of the operation performance may include comparing a first performance to a second performance, the first performance comprising a performance of the sensing operation, a performance of the positioning operation, or a combination thereof using non-visual information of the environment, and the second performance may include a performance of the sensing operation, a performance of the positioning operation, or a combination thereof using visual information of the environment. In some cases, the second network node may be further configured to, based on a deviation between the first performance and the second performance exceeding a threshold: perform the signal-based sensing, the signal-based positioning operation, or the combination thereof; or use the new machine learning model.

In some embodiments, the positioning operation by the second network node may include a determination of a location of the second network node based on the environment imaging information received from the first network node. In some implementations, the determination of the location of the second network node may include using a machine learning model configured to output a predicted location of the second network node.

In some embodiments, the sensing operation by the second network node may include a determination of a location of an object in the environment, a distance of the object relative to the second network node, or a combination thereof, based on the environment imaging information received from the first network node. In some implementations, the determination of the location of the object, the distance of the object, or the combination thereof may include using a machine learning model configured to output a predicted location of the object, a predicted distance of the object, or a combination thereof.

In some variants, the machine learning model may be further configured to output a probability associated with the predicted location, and the determination of the location of the second network node or the object may include a determination that the probability of the predicted location meets or exceeds a threshold, or has a higher probability than other predicted locations.

In some embodiments, the second network node may be configured to receive the environment imaging information from the first network node and additional environment imaging information from one or more additional first network nodes in the wireless network. For example, mTRP communication may be used to receive vision information at the second network node from multiple network nodes.

In some embodiments, the method 700 may further include obtaining metadata relating to the first network node, and sending the metadata to the second network node, the metadata comprising position information of the first network node, temporal information associated with the environment imaging information, a quantity of one or more objects in the environment, or a combination thereof. In some implementations, the method 700 may further include sending the position information of the first network node to the second network node.

In some embodiments, the method 700 may further include: updating at least a portion of the environment imaging information; and sending, from the first network node, at least the updated portion of the environment imaging information to the second network node. In some implementations, the method 700 may further include obtaining, via the first network node, further environment imaging information relating to the environment of the first network node. In some cases, the updating of at least the portion of the environment imaging information may be based on the further environment imaging information. For example, as noted above, multiple messages containing vision information may be sent to the second network node, where prior information may be successfully updated or refined.

In some embodiments, the method 700 may further include: obtaining ground truth information based on at least a portion of the environment imaging information, the ground truth information configured for training a machine learning model implemented by at least the second network node. In some cases, the sending of the environment imaging information to the second network node may include sending the ground truth information to the second network node with the environment imaging information.

Means for performing functionality at block 720 may comprise processor(s) 910, wireless communication interface 930, processor(s) 1010, wireless communication interface 1030, and/or other components of a UE or a base station, as illustrated in FIGS. 9 and 10.

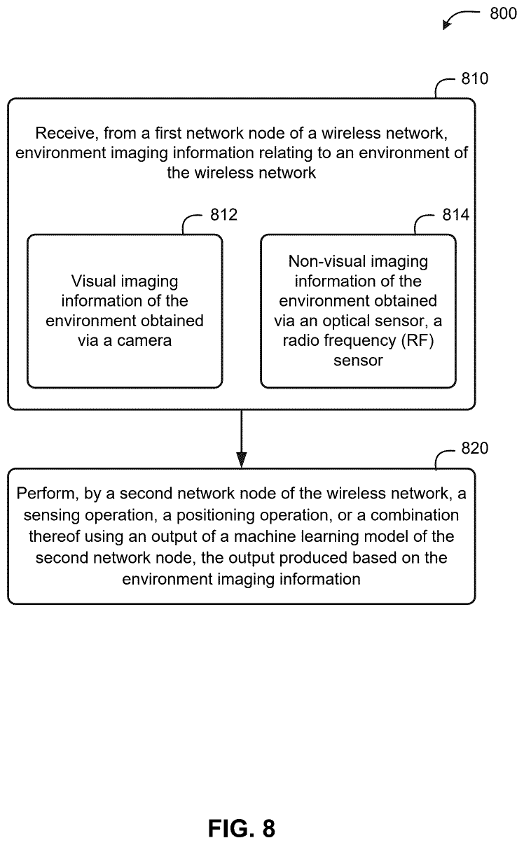

FIG. 8 is a flow diagram of a method 800 of sharing information in a wireless network, according to some embodiments. Structure for performing the functionality illustrated in one or more of the blocks shown in FIG. 8 may include hardware and/or software components of a network node, such as, for example, a controller apparatus, a computerized system, or a computer-readable apparatus including a storage medium storing computer-readable and/or computer-executable instructions that are configured to, when executed by at least one processor apparatus, cause the at least one processor apparatus or the network node to perform the operations. Example components of a network node, e.g., UE, base station, and/or server, are illustrated FIGS. 9, 10 and 11, which is described in more detail below.

It should also be noted that the operations of FIG. 8 may be performed in any suitable order, not necessarily the order depicted in FIG. 8. Further, the process shown in FIG. 8 may include additional or fewer operations than those depicted in FIG. 8.

At block 810, the method 800 may include receiving, from a first network node of the wireless network, environment imaging information relating to an environment of the wireless network. Similar to block 710, in some embodiments, the environment imaging information may include vision information, including: visual imaging information 812 of the environment obtained via a camera, non-visual imaging information 814 of the environment obtained via an optical sensor, a radio frequency (RF) sensor, or a combination thereof. In some cases, the camera, the optical sensor, the RF sensor, or the combination thereof may be associated with the first network node.

In some embodiments, the method 800 may further include sending a request to the first network node, wherein the receiving of the environment imaging information from the first network node may be responsive to the request.

Means for performing functionality at block 810 may comprise wireless communication interface 930, wireless communication interface 1030, and/or other components of a UE or a base station, as illustrated in FIGS. 9 and 10.

At block 820, the method 800 may include performing, by a second network node of the wireless network, a sensing operation, a positioning operation, or a combination thereof using an output of a machine learning model of the second network node, the output produced based on at least a portion of the environment imaging information.

In some embodiments, blocks 810 and 820 may be performed by the second network node. In some cases, the first network node may include a first user equipment (UE), a first base station, or a first wireless access point; and the second network node may include a second UE, a second base station, or a second wireless access point.

In some configurations, the machine learning model may be implemented by a second network node receiving the environment imaging information. In some implementations, the machine learning model may be trained using (i) ground truth information known to the wireless network, and (ii) environment imaging information obtained by the first network node, the second network node, or a combination thereof.

In some embodiments, the receiving of the environment imaging information may include receiving, from the first network node, ground truth information based on at least a portion of the environment imaging information, the ground truth information configured for training the machine learning model.

In some embodiments, the performing of the sensing operation, the positioning operation, or the combination thereof may include: inputting at least a portion of the environment imaging information to the machine learning model, wherein the machine learning model is trained using (i) ground truth information known to the wireless network, and (ii) environment imaging information obtained by the first network node, the second network node, or a combination thereof; and using the machine learning model to output information for the sensing operation, the positioning operation, or the combination thereof. In some implementations, the method 800 may further include receiving the position information of the first network node.

In some embodiments, the sensing operation, the positioning operation, or the combination by the second network node may include monitoring an operation performance by the second network node using the environment imaging information. In some implementations, the method 800 may further include, based on the operation performance, performing, via the second network node: a signal-based sensing operation, a signal-based positioning operation, or a combination thereof; a machine learning model-based sensing operation, a machine learning model-based positioning operation, or a combination thereof; receiving a new machine learning model for the machine learning model-based sensing operation or the machine learning model-based positioning operation; or a combination thereof.

In some cases, the monitoring of the operation performance may include comparing a first performance to a second performance, the first performance comprising a performance of the sensing operation, a performance of the positioning operation, or a combination thereof using non-visual information of the environment, and the second performance may include a performance of the sensing operation, a performance of the positioning operation, or a combination thereof using visual information of the environment. In some implementations, the method 800 may further include, based on a deviation between the first performance and the second performance exceeding a threshold: performing the signal-based sensing, the signal-based positioning operation, or the combination thereof; or using the new machine learning model.

Means for performing functionality at block 820 may include processor(s) 910, wireless communication interface 930, processor(s) 1010, wireless communication interface 1030, and/or other components of a UE or a base station, as illustrated in FIGS. 9 and 10.

In some embodiments, the method 800 may further include receiving, from the first network node, at least an updated portion of the environment imaging information. In some implementations, the at least the updated portion of the environment imaging information may be based on further environment imaging information relating to the environment of the first network node.

In some embodiments, the method 800 may further include receiving additional environment imaging information from one or more additional first network nodes in the wireless network. In some implementations, the output of the machine learning model used in the performing of the sensing operation, the positioning operation, or the combination thereof may be further based on the additional environment imaging information.

### Apparatus

FIG. 9 is a block diagram of an embodiment of a UE 105, which can be utilized as described herein above (e.g., in association with FIGS. 1, 2, 4, 5, 7 and 8). For example, the UE 105 can perform one or more of the functions of the method shown in FIG. 7. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 105 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 105 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 105 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s) (e.g., lidar), infrared sensor(s), RF sensor(s) (e.g., radar), barometer(s), and the like), some of which may be used to obtain position-related measurements and/or other information. In some configurations, the sensor(s) 940 may not be co-located with the UE 105, e.g., communicatively coupled (wired or wirelessly) but not disposed at the UE 105.

Embodiments of the UE 105 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The UE 105 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 105 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 105 (and/or processor(s) 910 or DSP 920 within UE 105). In some embodiments, then, such code and/or instructions can be used to configure and/or adapt a general-purpose computer (or other device) to perform one or more operations in accordance with the described methods.

FIG. 10 is a block diagram of an embodiment of a base station 120, which can be utilized as described herein above (e.g., in association with FIGS. 1, 2, 4, 5, 7 and 8). It should be noted that FIG. 10 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1005 (or may otherwise be in communication, as appropriate). The hardware elements may include a processor(s) 1010 which can include without limitation one or more general-purpose processors, one or more special-purpose processors (such as DSP chips, graphics acceleration processors, ASICs, and/or the like), and/or other processing structure or means. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1030 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1032 that send and/or receive wireless signals 1034.

The base station 120 may also include a network interface 1080, which can include support of wireline communication technologies. The network interface 1080 may include a modem, network card, chipset, and/or the like. The network interface 1080 may include one or more input and/or output communication interfaces to permit data to be exchanged with a network, communication network servers, computer systems, and/or any other electronic devices described herein.

In many embodiments, the base station 120 may further comprise a memory 1060. The memory 1060 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1060 of the base station 120 also may comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the base station 120 (and/or processor(s) 1010 or DSP 1020 within base station 120). In some embodiments, then, such code and/or instructions can be used to configure and/or adapt a general-purpose computer (or other device) to perform one or more operations in accordance with the described methods.

The base station 120 may also include one or more sensor(s) 1040. Sensor(s) 940 may include, without limitation, one or more inertial sensors and/or other sensors (e.g., accelerometer(s), gyroscope(s), camera(s), magnetometer(s), altimeter(s), microphone(s), proximity sensor(s), light sensor(s) (e.g., lidar), infrared sensor(s), RF sensor(s) (e.g., radar), barometer(s), and the like), some of which may be used to obtain position-related measurements and/or other information. In some configurations, the sensor(s) 1040 may not be co-located with the base station 120, e.g., communicatively coupled (wired or wirelessly) but not disposed at the base station 120.

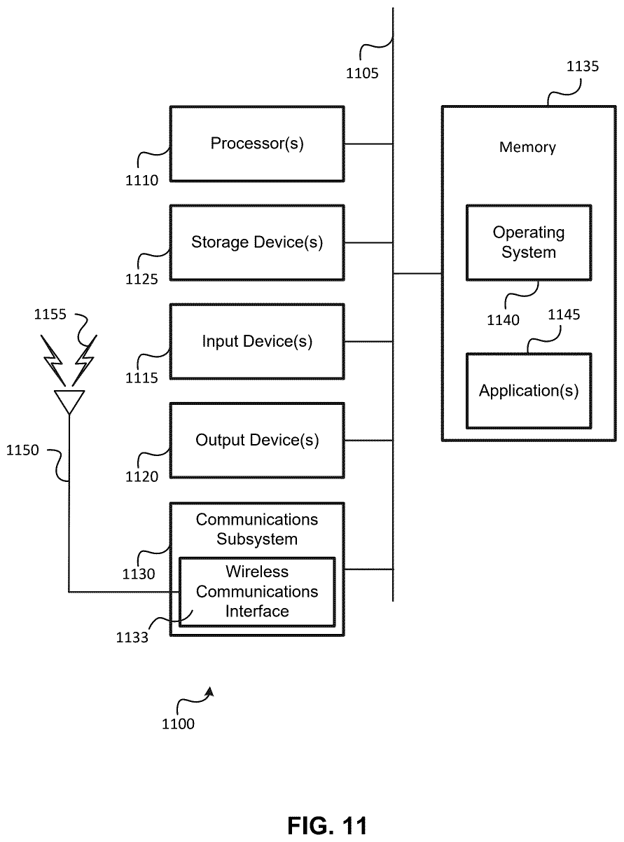

FIG. 11 is a block diagram of an embodiment of a computer system 1100, which may be used, in whole or in part, to provide the functions of one or more network components as described in the embodiments herein (e.g., location/sensing server 160 of FIG. 1). It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner. In addition, it can be noted that components illustrated by FIG. 11 can be localized to a single device and/or distributed among various networked devices, which may be disposed at different geographical locations.

The computer system 1100 is shown comprising hardware elements that can be electrically coupled via a bus 1105 (or may otherwise be in communication, as appropriate). The hardware elements may include processor(s) 1110, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1100 also may comprise one or more input devices 1115, which may comprise without limitation a mouse, a keyboard, a camera, a microphone, and/or the like; and one or more output devices 1120, which may comprise without limitation a display device, a printer, and/or the like.

The computer system 1100 may further include (and/or be in communication with) one or more non-transitory storage devices 1125, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1100 may also include a communications subsystem 1130, which may comprise wireless communication technologies managed and controlled by a wireless communication interface 1133, as well as wired technologies (such as Ethernet, coaxial communications, universal serial bus (USB), and the like). The wireless communication interface 1133 may comprise one or more wireless transceivers that may send and receive wireless signals 1155 (e.g., signals according to 5G NR or LTE) via wireless antenna(s) 1150. Thus the communications subsystem 1130 may comprise a modem, a network card (wireless or wired), an infrared communication device, a wireless communication device, and/or a chipset, and/or the like, which may enable the computer system 1100 to communicate on any or all of the communication networks described herein to any device on the respective network, including a User Equipment (UE), base stations and/or other TRPs, and/or any other electronic devices described herein. Hence, the communications subsystem 1130 may be used to receive and send data as described in the embodiments herein.

In many embodiments, the computer system 1100 will further comprise a working memory 1135, which may comprise a RAM or ROM device, as described above. Software elements, shown as being located within the working memory 1135, may comprise an operating system 1140, device drivers, executable libraries, and/or other code, such as one or more applications 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1125 described above. In some cases, the storage medium might be incorporated within a computer system, such as computer system 1100. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of sharing information in a wireless network, the method comprising: receiving, from a first network node of the wireless network, environment imaging information relating to an environment of the wireless network, the environment imaging information comprising: visual imaging information of the environment obtained via a camera; non-visual imaging information of the environment obtained via an optical sensor, a radio frequency (RF) sensor, or a combination thereof; or a combination thereof; and performing, by a second network node of the wireless network, a sensing operation, a positioning operation, or a combination thereof using an output of a machine learning model of the second network node, the output produced based on at least a portion of the environment imaging information.
Clause 2. The method of clause 1, wherein the visual imaging information of the environment comprises raw image or video data, one or more processed images or videos, or a combination thereof.
Clause 3. The method of clause 1, wherein the visual imaging information of the environment comprises segmentation information associated with one or more objects in the environment.
Clause 4. The method of clause 1, wherein the first network node comprises a first user equipment (UE), a first base station, or a first wireless access point; and the second network node comprises a second UE, a second base station, or a second wireless access point.
Clause 5. The method of clause 1, wherein the performing of the sensing operation, the positioning operation, or the combination thereof comprises: inputting at least a portion of the environment imaging information to the machine learning model, wherein the machine learning model is trained using (i) ground truth information known to the wireless network, and (ii) environment imaging information obtained by the first network node, the second network node, or a combination thereof; and using the machine learning model to output information for the sensing operation, the positioning operation, or the combination thereof.
Clause 6. The method of clause 1, further comprising obtaining metadata relating to the first network node, the metadata comprising position information of the first network node, temporal information associated with the environment imaging information, a quantity of one or more objects in the environment, or a combination thereof.
Clause 7. The method of clause 6, further comprising receiving the position information of the first network node.
Clause 8. The method of clause 1, further comprising sending a request to the first network node, wherein the receiving of the environment imaging information from the first network node is responsive to the request.
Clause 9. The method of clause 1, further comprising receiving, from the first network node, at least an updated portion of the environment imaging information.
Clause 10. The method of clause 9, wherein the at least the updated portion of the environment imaging information is based on further environment imaging information relating to the environment of the first network node.
Clause 11. The method of clause 1, wherein the receiving of the environment imaging information comprises receiving, from the first network node, ground truth information based on at least a portion of the environment imaging information, the ground truth information configured for training the machine learning model.
Clause 12. The method of clause 1, wherein the sensing operation, the positioning operation, or the combination by the second network node comprises monitoring an operation performance by the second network node using the environment imaging information; and the method further comprises, based on the operation performance, performing, via the second network node: a signal-based sensing operation, a signal-based positioning operation, or a combination thereof; a machine learning model-based sensing operation, a machine learning model-based positioning operation, or a combination thereof; receiving a new machine learning model for the machine learning model-based sensing operation or the machine learning model-based positioning operation; or a combination thereof.
Clause 13. The method of clause 12, wherein the monitoring of the operation performance comprises comparing a first performance to a second performance, the first performance comprising a performance of the sensing operation, a performance of the positioning operation, or a combination thereof using non-visual information of the environment, and the second performance comprises a performance of the sensing operation, a performance of the positioning operation, or a combination thereof using visual information of the environment; and the method further comprises, based on a deviation between the first performance and the second performance exceeding a threshold: performing the signal-based sensing, the signal-based positioning operation, or the combination thereof; or using the new machine learning model.
Clause 14. The method of clause 1, wherein: the positioning operation by the second network node comprises a determination of a location of the second network node based on the environment imaging information received from the first network node; and the determination of the location of the second network node comprises using a machine learning model configured to output a predicted location of the second network node.
Clause 15. The method of clause 1, wherein: the sensing operation by the second network node comprises a determination of a location of an object in the environment, a distance of the object relative to the second network node, or a combination thereof, based on the environment imaging information received from the first network node; and the determination of the location of the object, the distance of the object, or the combination thereof comprises using a machine learning model configured to output a predicted location of the object, a predicted distance of the object, or a combination thereof.
Clause 16. The method of clause 1, further comprising receiving additional environment imaging information from one or more additional first network nodes in the wireless network; wherein the output of the machine learning model used in the performing of the sensing operation, the positioning operation, or the combination thereof is further based on the additional environment imaging information.
Clause 17. A network apparatus comprising: one or more transceivers; one or more memories; a machine learning model; and one or more processors communicatively coupled with the one or more transceivers, the one or more memories, and the machine learning model, wherein the one or more processors are configured to: receive, from another network apparatus via the one or more transceivers, environment imaging information relating to an environment of a wireless network, the environment imaging information comprising: visual imaging information of the environment obtained via a camera; non-visual imaging information of the environment obtained via an optical sensor, a radio frequency (RF) sensor, or a combination thereof; or a combination thereof; and perform a sensing operation, a positioning operation, or a combination thereof using an output of the machine learning model, the output produced based on at least a portion of the environment imaging information.
Clause 18. The network apparatus of clause 17, wherein the performance of the sensing operation, the positioning operation, or the combination thereof comprises: inputting the environment imaging information to the machine learning model, wherein the machine learning model is trained using (i) ground truth information known to the wireless network, and (ii) environment imaging information obtained by the network apparatus, the another network apparatus, or a combination thereof; and using the machine learning model to output information for the sensing operation, the positioning operation, or the combination thereof.
Clause 19. A non-transitory computer-readable apparatus comprising a storage medium, the storage medium comprising a plurality of instructions configured to, when executed by one or more processors, cause a network apparatus of a wireless network to: receive, from another network apparatus, environment imaging information relating to an environment of the wireless network, the environment imaging information comprising: visual imaging information of the environment obtained via a camera; non-visual imaging information of the environment obtained via an optical sensor, a radio frequency (RF) sensor, or a combination thereof; or a combination thereof; and perform a sensing operation, a positioning operation, or a combination thereof using an output of a machine learning model of the network apparatus, the output produced based on at least a portion of the environment imaging information.
Clause 20. The non-transitory computer-readable apparatus of clause 19, wherein the performance of the sensing operation, the positioning operation, or the combination thereof comprises: inputting the environment imaging information to the machine learning model, wherein the machine learning model is trained using (i) ground truth information known to the wireless network, and (ii) environment imaging information obtained by the network apparatus, the another network apparatus, or a combination thereof; and using the machine learning model to output information for the sensing operation, the positioning operation, or the combination thereof.

What is claimed is:

1. A method of sharing information in a wireless network, the method comprising:
receiving, from a first network node of the wireless network, environment imaging information relating to an environment of the wireless network, the environment imaging information comprising:
visual imaging information of the environment obtained via a camera;
non-visual imaging information of the environment obtained via an optical sensor, a radio frequency (RF) sensor, or a combination thereof; or
a combination thereof; and
performing, by a second network node of the wireless network, a sensing operation, a positioning operation, or a combination thereof using an output of a machine learning model of the second network node, the output produced based on at least a portion of the environment imaging information.

2. The method of claim 1, wherein the visual imaging information of the environment comprises raw image or video data, one or more processed images or videos, or a combination thereof.

3. The method of claim 1, wherein the visual imaging information of the environment comprises segmentation information associated with one or more objects in the environment.

4. The method of claim 1, wherein the first network node comprises a first user equipment (UE), a first base station, or a first wireless access point; and the second network node comprises a second UE, a second base station, or a second wireless access point.

5. The method of claim 1, wherein the performing of the sensing operation, the positioning operation, or the combination thereof comprises:
inputting at least a portion of the environment imaging information to the machine learning model, wherein the machine learning model is trained using (i) ground truth information known to the wireless network, and (ii) environment imaging information obtained by the first network node, the second network node, or a combination thereof; and
using the machine learning model to output information for the sensing operation, the positioning operation, or the combination thereof.

6. The method of claim 1, further comprising obtaining metadata relating to the first network node, the metadata comprising position information of the first network node, temporal information associated with the environment imaging information, a quantity of one or more objects in the environment, or a combination thereof.

7. The method of claim 6, further comprising receiving the position information of the first network node.

8. The method of claim 1, further comprising sending a request to the first network node, wherein the receiving of the environment imaging information from the first network node is responsive to the request.

9. The method of claim 1, further comprising receiving, from the first network node, at least an updated portion of the environment imaging information.

10. The method of claim 9, wherein the at least the updated portion of the environment imaging information is based on further environment imaging information relating to the environment of the first network node.

11. The method of claim 1, wherein the receiving of the environment imaging information comprises receiving, from the first network node, ground truth information based on at least a portion of the environment imaging information, the ground truth information configured for training the machine learning model.

12. The method of claim 1, wherein the sensing operation, the positioning operation, or the combination by the second network node comprises monitoring an operation performance by the second network node using the environment imaging information; and
the method further comprises, based on the operation performance, performing, via the second network node:
a signal-based sensing operation, a signal-based positioning operation, or a combination thereof;
a machine learning model-based sensing operation, a machine learning model-based positioning operation, or a combination thereof;
receiving a new machine learning model for the machine learning model-based sensing operation or the machine learning model-based positioning operation; or
a combination thereof.

13. The method of claim 12, wherein the monitoring of the operation performance comprises comparing a first performance to a second performance, the first performance comprising a performance of the sensing operation, a performance of the positioning operation, or a combination thereof using non-visual information of the environment, and the second performance comprises a performance of the sensing operation, a performance of the positioning operation, or a combination thereof using visual information of the environment; and
the method further comprises, based on a deviation between the first performance and the second performance exceeding a threshold:
performing the signal-based sensing, the signal-based positioning operation, or the combination thereof; or
using the new machine learning model.

14. The method of claim 1, wherein:
the positioning operation by the second network node comprises a determination of a location of the second network node based on the environment imaging information received from the first network node; and
the determination of the location of the second network node comprises using a machine learning model configured to output a predicted location of the second network node.

15. The method of claim 1, wherein:
the sensing operation by the second network node comprises a determination of a location of an object in the environment, a distance of the object relative to the second network node, or a combination thereof, based on the environment imaging information received from the first network node; and
the determination of the location of the object, the distance of the object, or the combination thereof comprises using a machine learning model configured to output a predicted location of the object, a predicted distance of the object, or a combination thereof.

16. The method of claim 1, further comprising receiving additional environment imaging information from one or more additional first network nodes in the wireless network;
wherein the output of the machine learning model used in the performing of the sensing operation, the positioning operation, or the combination thereof is further based on the additional environment imaging information.

17. A network apparatus comprising:
one or more transceivers;
one or more memories;
a machine learning model; and
one or more processors communicatively coupled with the one or more transceivers, the one or more memories, and the machine learning model, wherein the one or more processors are configured to:
receive, from another network apparatus via the one or more transceivers, environment imaging information relating to an environment of a wireless network, the environment imaging information comprising:
visual imaging information of the environment obtained via a camera;
non-visual imaging information of the environment obtained via an optical sensor, a radio frequency (RF) sensor, or a combination thereof; or
a combination thereof; and
perform a sensing operation, a positioning operation, or a combination thereof using an output of the machine learning model, the output produced based on at least a portion of the environment imaging information.

18. The network apparatus of claim 17, wherein the performance of the sensing operation, the positioning operation, or the combination thereof comprises:
inputting the environment imaging information to the machine learning model, wherein the machine learning model is trained using (i) ground truth information known to the wireless network, and (ii) environment imaging information obtained by the network apparatus, the another network apparatus, or a combination thereof; and
using the machine learning model to output information for the sensing operation, the positioning operation, or the combination thereof.

19. A non-transitory computer-readable apparatus comprising a storage medium, the storage medium comprising a plurality of instructions configured to, when executed by one or more processors, cause a network apparatus of a wireless network to:
receive, from another network apparatus, environment imaging information relating to an environment of the wireless network, the environment imaging information comprising:
visual imaging information of the environment obtained via a camera;
non-visual imaging information of the environment obtained via an optical sensor, a radio frequency (RF) sensor, or a combination thereof; or
a combination thereof; and
perform a sensing operation, a positioning operation, or a combination thereof using an output of a machine learning model of the network apparatus, the output produced based on at least a portion of the environment imaging information.

20. The non-transitory computer-readable apparatus of claim 19, wherein the performance of the sensing operation, the positioning operation, or the combination thereof comprises:
inputting the environment imaging information to the machine learning model, wherein the machine learning model is trained using (i) ground truth information known to the wireless network, and (ii) environment imaging information obtained by the network apparatus, the another network apparatus, or a combination thereof; and
using the machine learning model to output information for the sensing operation, the positioning operation, or the combination thereof.
